(19) United States
(12) Patent Application Publication
(10) Pub. No.: US 2016/0050298 A1
(43) Pub. Date: Feb. 18, 2016

(54) ONTOLOGY-BASED WAVEFORM RECONFIGURATION

(71) Applicant: NORTHEASTERN UNIVERSITY, Boston, MA (US)

(72) Inventors: Leszek Janusz Lechowicz, Bridgewater, MA (US); Mieczyslaw Kokar, Framingham, MA (US)

(21) Appl. No.: 14/782,748

(22) PCT Filed: Apr. 11, 2014
(86) PCT No.: PCT/US14/33831

§ 371 Date: Oct. 6, 2015

Related U.S. Application Data
(60) Provisional application No. 61/811,310, filed on Apr. 12, 2013.

(51) Int. Cl. H04L 29/06

(52) U.S. Cl. CPC H04L 69/08; H04L 69/18

(57) ABSTRACT

A first node communicating with a second node over a connection having a first protocol receives a request to reconfigure the connection to operate on a second protocol. An agent executing on the first node determines that the first node requires a protocol component to communicate using the second protocol. The first node requests a description of the second protocol and receives the description of the second protocol from the second node. The description includes a structural description and a state machine description. An inference engine of the first node generates a composite model of the second protocol based on the structural description and the state machine description. The first node uses the composite model to construct a second protocol component configured to communicate using the second protocol. The first node transmits a signal over the second protocol to the second node using the second protocol component.

### CROSS-REFERENCES TO RELATED APPLICATIONS

This application is a national phase application of international patent application No. PCT/US2014/33831, filed on Apr. 11, 2014 which itself claims priority under 35 U.S.C. §119 to U.S. Provisional Patent Application No. 61/811,310, filed Apr. 12, 2013, the contents of each are incorporated by reference herein in their entirety.

### BACKGROUND

Communication devices communicate with one another using predefined waveforms. Challenges may arise when a first device attempts to communicate with a second device using a new waveform that is not known by the second device.

### SUMMARY OF THE DISCLOSURE

Systems and methods of the present disclosure are directed to ontology-based waveform reconfiguration that allows radios (or nodes) of different hardware or software architectures, using different software APIs or non-uniform waveform description schemas, to interoperate. In some embodiments, different nodes share the same base software-defined radio ontology. Sharing the same base software-defined radio ontology can allow the different nodes to understand concepts associated with a communication protocol or waveform description in a uniform way, thus facilitating transfer of more complex concepts or components from one node to another node. During reconfiguration, a node can receive a description of a protocol (or waveform) expressed in a Web Ontology Language (“OWL”) and rules and then automatically configure the node's processing according to the description.

At least one aspect is directed to a method of reconfiguring a connection protocol. In some embodiments, the method includes a first node receiving, from a second node with which it communicates using a first protocol over a connection, a request to reconfigure the connection to operate on a second protocol. The method can include an agent executing on the first node determining that the first node requires a protocol component to communicate using the second protocol. The method can include the first node requesting a description of the second protocol. The first node can request the description based on the determination that a protocol component is required to communicate using the second protocol. The method can include the first node receiving, from the second node, the description of the second protocol. The description can include a structural description and a state machine description. The method can include an inference engine of the first node generating a composite model of the second protocol based on the structural description and the state machine description. The method can include the first node using the composite model to construct a second protocol component configured to communicate using the second protocol. The method can include the first node transmitting a signal to the second node using the second protocol. The first node can transmit the signal via the constructed second protocol component of the first node.

In some embodiments, the second protocol includes at least one of an encryption protocol and an authentication protocol that are different from the first protocol. In some embodiments, the first node receives the description of the second protocol in an ontology language. In some embodiments, the method includes the first node receiving rules corresponding to the description of the second protocol. The method can include the first node generating the composite model based on the rules. In some embodiments, the method includes the first node receiving the state machine description that includes a description of instances of at least one of states, transitions and guards. In some embodiments, the method includes the first node receiving the structural description that includes instances of at least one of components, ports, and signals.

In some embodiments, the method includes the first node determining that the first node requires an additional protocol component to communicate using the second protocol. The first node can make this determination responsive to receiving the description of the second protocol. In some embodiments, the method can include the first node requesting a second description of the additional component. The first node can make this request based on the determination that the first node requires an additional protocol component. In some embodiments, the method includes the first node receiving the second description corresponding to the additional component. The second description can be a lower level description than the description previously received by the first node. In some embodiments, the method includes the first node obtaining information used to construct the second protocol component via a recurrent query-response exchange between the second node and the first node.

In some embodiments, the method includes the inference engine connecting interfaces identified by the description to generate the composite model. The method can include mapping the composite model to a plurality of components of the first node. The plurality of components can include at least one of a software component, a hardware component, and a firmware component. In some embodiments, the method can include the inference engine generating the composite model using a correct-by-construction process. In some embodiments, the method can include using an instantiation parameter to construct the second protocol component.

In some embodiments, the second node and the first node include a same base software-defined radio ontology. In some embodiments, the second node uses a different software architecture or hardware architecture than the first node.

Another aspect is directed to a system that reconfigures a connection protocol. The system can include a first node having one or more processors. The system can include an interface module of the first node configured to receive a request to reconfigure the connection to operate on a second protocol. The interface module can receive the request from a second node with which it communicates using a first protocol over a connection. The system can include an agent executing on one or more processor of the first node. The agent can be configured to determine that the first node requires a protocol component to communicate using the second protocol. The agent can be further configured to request a description of the second protocol based on the determination. The system can include an inference engine executing on the first node. The inference engine is configured to receive the description of the second protocol. The description can include a structural description and a state machine description. The inference engine is further configured to generate a composite model of the second protocol based on the structural description and the state machine description. The inference engine is further configured to use the composite model to construct a second protocol component configured to communicate using the second protocol. The interface module is further configured to transmit, via the constructed second protocol component of the first node, a signal to the second node using the second protocol.

In some embodiments, the second protocol includes at least one of an encryption protocol and an authentication protocol that are different from the first protocol. In some embodiments, the first node is further configured to receive the description in an ontology language. In some embodiments, the first node is further configured to receive rules corresponding to the description of the second protocol. The first node can be further configured to generate the composite model based on the rules.

In some embodiments, the first node is further configured to determine, responsive to receiving the description of the second protocol, that the first node requires an additional protocol component to communicate using the second protocol. The first node is further configured to request a second description of the additional component based on the determination. The first node is further configured to receive the second description corresponding to the additional component. The second description being lower level than the description.

In some embodiments, the inference engine can be further configured to connect interfaces identified by the description to generate the composite model. The inference engine is further configured to map the composite model to multiple components of the first node. The multiple components can include at least one of a software component, a hardware component, and a firmware component. In some embodiments, the inference engine is further configured to generate the composite model using a correct-by-construction process.

### BRIEF DESCRIPTION OF THE DRAWINGS

The figures are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 is an illustration of an example system for reconfiguring a connection protocol in accordance with an embodiment.

FIG. 2 is an illustration of external inputs and an external output of an example component in accordance with an embodiment.

FIG. 3 is an illustration of data elements corresponding to external connections of a component in accordance with an embodiment.

FIG. 4 is an illustration of an example state machine transition diagram in accordance with an embodiment.

FIG. 5 is an illustration of example individuals in a component composition in accordance with an embodiment.

FIGS. 6-10 are illustrations of example stages of constructing a composite component in accordance with an embodiment.

FIG. 11 is a flow chart illustrating an example method for reconfiguring a connection protocol in accordance with an embodiment.

FIG. 12 illustrates a block diagram for a system to facilitate reconfiguring a connection protocol in accordance with an embodiment.

FIG. 13 illustrates a decomposition of a BPSK31 TXChannel, in accordance with an embodiment.

FIG. 14 illustrates an example PSK31CharEncoder component in accordance with an embodiment.

FIG. 15 illustrates an example state transition diagram for a PSK31TxStateMachine, in accordance with an embodiment.

Like reference numbers and designations in the various drawings indicate like elements.

### DETAILED DESCRIPTION

Systems and methods of the present disclosure are directed to allowing communication devices (e.g., nodes) to dynamically reconfigure themselves by following formal descriptions in a correct-by-construction manner. The systems and methods can reconfigure communication devices with different hardware and/or software architectures that might use different software APIs and even non-uniform waveform description schemas.

In some embodiments, waveform reconfiguration is based on a transfer of a description (e.g., facts and rules) expressed in an ontology language (e.g., Web Ontology Language “OWL”) and a rule language (e.g., BaseVISor). The description can be transferred between nodes (e.g., radios, cognitive radios, communication devices, wireless communication devices, etc.) that use the same base ontology, such as a standardized base Software-defined Radio (“SDR”) ontology. Using the same base ontology facilitates interoperability between the nodes because higher level concepts or components of the description can be decomposed into concepts that are defined in the base ontology.

For example, a first node that is in communication with a second node can receive a reconfiguration request (e.g., a request to use a different communication protocol or waveform) from the second node to communicate using a new protocol or waveform. When the first node receives the reconfiguration request from the second node, the first node can determine whether the first node is familiar with a software component necessary to communicate via the new protocol associated with the reconfiguration request. If the first node is not familiar with the software component, the first node can send a query to the second node that originated the request (or another node that the first node identifies as having the description) to obtain the description of the unknown component.

In some embodiments, the received description may be compressed in order to reduce the size of the data file to facilitate transferring the description. The description can specify the component using two types of information. The first type of information may be referred to as a structural description and can describe the component as a composition of other, simpler components. A second type of description can describe the component as a state machine (e.g., a finite state machine), which may facilitate describing behaviors of the component. The components described by these two types of information may be externally similar in that they may use the same or substantially similar external interface, ports, signals, etc., to connect with other components. In the event the description further includes components unknown to the first node, the first node can send additional queries to the second node for a lower level description of the additional unknown component.

When the first node obtains the description of the waveform, the first node can use an inference engine to generate state machines and build a composite model of the waveform. The inference engine may do this by generating OWL individuals connecting them based on relationships between and the specified rules. The constructed composite model is then used to instantiate state machines and other software components and connect them according to the model. In some embodiments, the first node can construct the waveform model (e.g., a composite component) through a correct-by-construction approach, which may mitigate issues related to differences in interpretation of the waveform descriptions across different communication device or cognitive radio platforms. Thus, the first node can receive a description of a waveform it did not know before (from another node) and construct the waveform from the description. Then both nodes can use the waveform for further communication.

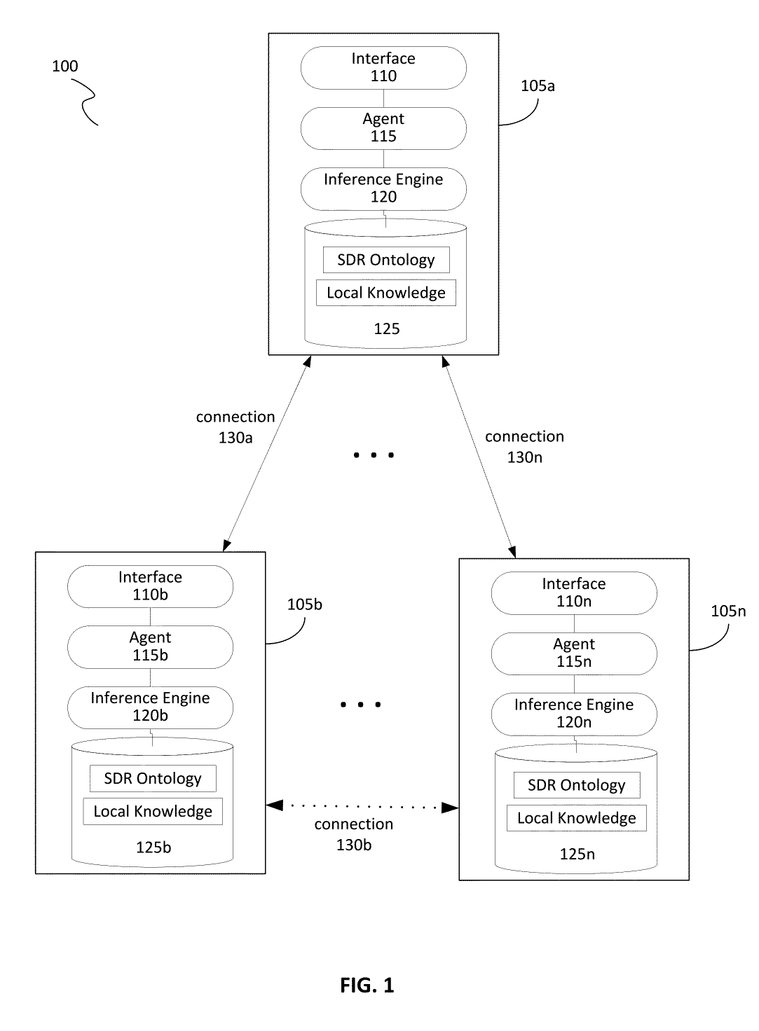

FIG. 1 illustrates an example system 100 for reconfiguring a connection protocol in accordance with an embodiment. In brief overview, and in some embodiments, the system 100 includes a node 105a. The node 105a may refer to or include a software-defined radio (“SDR”), communication device, radio, cognitive radio, wireless radio, wireless communication device, etc. In some embodiments, the node 105a includes an interface 110, agent 115, inference engine 120, and database 125. In some embodiments, the system 100 can include one or more nodes 105a-n, that may each include a respective interface 110, agent 115, inference engine 120, and database 125. In some embodiments, the databases 125a-n of each node 105a-n may include the same base SDR ontology, while the databases 125a-n of each node 105a-n may include the same or different local knowledge.

The nodes 105a-n can include one or more computing device configured to perform one or more functions of the system 100. The computing device can include at least one of a processor, bus, main memory, ROM, a storage device, an interface, an input device, and a display device. The computing device can include or perform one or more function associated with the interface 110, agent 115, inference engine 120, and database 125. The nodes 105a-n can include a bus or other communication component for communicating information and one or more a processors or processing circuitry coupled to the bus for processing information. The nodes 105a-n can also include one or more processors or processing circuitry coupled to the bus for processing information. The nodes 105a-n also includes main memory, such as a random access memory (RAM) or other dynamic storage device, coupled to the bus for storing information, and instructions to be executed by the processor. Main memory can also be used for storing information, temporary variables, or other intermediate information during execution of instructions by the processor. The nodes 105a-n may further include a read only memory (ROM) or other static storage device coupled to the bus for storing static information and instructions for the processor. A storage device, such as a solid state device, magnetic disk or optical disk, can be coupled to the bus for persistently storing information and instructions.

In some embodiments, the nodes 105a-n may include a display (not shown in FIG. 1) or be coupled to an external display via the bus. The display may include a liquid crystal display, or active matrix display, for displaying information to a user of the node 105. Although not shown in FIG. 1, an input device, such as a keyboard including alphanumeric and other keys, may be coupled to the bus for communicating information and command selections to the processor. In another implementation, the input device has a touch screen display. The input device can include a cursor control, such as a mouse, a trackball, or cursor direction keys, for communicating direction information and command selections to the processor and for controlling cursor movement on the display.

According to various implementations, the processes described herein can be implemented by the nodes 105a-n in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multi-processing arrangement may also be employed to execute the instructions contained in main memory. In alternative implementations, hard-wired circuitry may be used in place of or in combination with software instructions to effect illustrative implementations. Thus, embodiments are not limited to any specific combination of hardware circuitry and software.

In some embodiments, node 105a includes an interface 110 designed and constructed to receive and transmit information between one or more nodes 105b-n. In some embodiments, the system 100 includes a central communication server or data center or other computing device with which interface 110 is configured to communicate in order to facilitate systems and methods disclosed herein. For example, the interface 110 can communicate with a server or other computing device for initial setup and configuration of the node 105a, periodic updates to a software architecture, data or file transfer or backup, etc.

The interface 110 can include hardware or software components, including, e.g., input and output ports. In some embodiments, the interface 110 can be configured to receive and transmit information using one or more waveforms or protocols, such as wireless protocols or wired protocols. In some embodiments, the interface 110 can be reconfigured to use a new waveform protocol that the node 105 was not previously configured to use. In some embodiments, the interface 110 can include an external interface, such as an interface that communicates with devices external to node 105a. In some embodiments, the interface 110 can include internal interfaces, such as those interfaces that communicate between one or more software components or ports internal to the node 105.

The interface 110 can receive or transmit information via a communication channel or connection 130a-n with another node 105a-n or computing device. In some embodiments, the connection employs the OSI or TCP/IP model having multiple layers where each layer includes one or more protocols that define the syntax and semantics of packets. For example, an in some implementations, the connection can include a data link (e.g., higher levels of protocol having payload data) and a control link (e.g., signaling messages). In some embodiments, the connection 130a-n includes a network such as computer networks such as the Internet, local, wide, metro, data, or other area networks, intranets, satellite networks, combinations thereof, and other communication networks such as voice or data mobile telephone networks, wireless link, ATM (Asynchronous Transfer Mode) network, a SONET (Synchronous Optical Network) network, a SDH (Synchronous Digital Hierarchy) network, a wireless network and a wireline network. The network may include mobile device networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”).

A waveform or protocol can include one or more transformations (e.g., a set of transformations) applied to information to be transmitted and the corresponding one or more transformations to convert received signals back to their information content. In some embodiments, waveforms can be implemented as applications that are loaded on top of a middleware layer of one or more node 105a-n. A waveform can provide signal processing and waveform behavior. Signal processing includes the process of transforming the payload data (e.g., information data) into analog signal samples, or vice-versa. Signal processing can include operations such as filtering, modulation, demodulation, coding etc. In some embodiments, some or all of the signal path of the waveform can be represented as a composition of simpler (or lower level) signal processing components. Examples of waveforms may include BPSK31, QPSK31, RTTY, etc.

Waveform behavior includes or refers to waveform functionality that is not directly involved in the signal processing. This indirect waveform functionality may refer to managing the internal state of the waveform, responding to asynchronous events, etc. Since, in some embodiments, the behavior of a waveform corresponds to a finite number of internal states, the waveform behavior can be represented by one or more finite state machines. Finite state machines can also be used to describe non-standardized processing in the signal path of the waveform.

Accordingly, a description of a waveform includes a description of state machines and a structural description. The state machines encode the waveform's behavior and non-standard signal processing. The structural description of a composition can include the signal processing components, and may also include the state machine components created based on their descriptions. This structural description specifies the components, the interconnections between them and the connections between the waveform's external interfaces and the external interfaces of the specific internal components.

One or both of the description of the state machine and the structural description can include a form of facts and rules that are used to generate a model of the waveform. Such a model can include ontology individuals (e.g., OWL individuals) connected through properties. With reference to the state machine descriptions, properties can represent relations between instances of states, transitions, guards and other state-machine definition related concepts. With reference to the structural description, the properties of the ontology can represent relations between individuals, such as instances of components, ports, signals and other concepts that describe an internal structure of a composite component.

The node 105 includes a database 125 that stores an SDR ontology and local knowledge. The SDR ontology may refer to a base SDR ontology, and the local knowledge may refer to knowledge that is specific to the node, such as parameters and configuration information, components, descriptions, rules, state machines, etc. The node 105 can update the local knowledge as the node acquires knowledge about new components.

The base SDR ontology can include a standardized set of SDR-related concepts and their relationships. For example, the base SDR can include the Cognitive Radio Ontology (CRO) maintained by the WIRELESS INNOVATION FORUM (“WIF” or “WInnF”) of Reston, Va. In some embodiments, the base SDR can be based on the CRO, or be an extension of the CRO. Each node may have additional concepts in its ontology that extend the base ontology and can be stored as local knowledge. These additional concepts can be expressible in terms of the base ontology, thus facilitating interoperability among multiple nodes 105b-n. The node's SDR ontology, together with the node specific knowledge (e.g. node's configuration, waveform parameters, communication channel's QoS parameters etc.), constitutes the node's knowledge base.

The nodes 105a-n can use various ontological languages. For example, the ontology language may be based on Resource Description Framework (RDF), Resource Description Framework Schema (RDFS), or Web Ontology Language (OWL). However, the node 105a-n and inference engine can be configured to operate using various other languages.

The nodes 105a-n can employ various ontology languages. An ontology language may be selected based on various criteria, including, e.g., how well it describes structural or state machine elements or its compression ratio. In some embodiments, the ontology language the nodes 105a-n are configured to use is OWL. An ontology language can include a declarative language that can express facts about a specific domain, rather than prescribing a sequence of actions that a computer needs to perform. An ontology, along with such facts expressed using the terms from the ontology, can be referred to as a model of the domain. Therefore a declarative language, such as OWL, describes (or models) domains. The computational model associated with a declarative language involves an inference engine 120 (or reasoner) that performs computations on the models. The inference engine 120 derives new facts (or makes them explicit) from the facts expressed in the model. In the derivation process, the inference engine 120 uses axioms of the language and some general statements from the model.

The ontology language can include a number of basic concepts like classes, properties and individuals. Classes capture (describe) collections of entities. For example, a class may include ChannelDecoder and individuals may include all instances of channel decoders. A specific individual, e.g., ChannelDecoder1, can be an instance of the ChannelDecoder class. OWL properties are used to relate instances of classes. For example, the property hasPort can capture the relationships between components and ports (instances of classes called RadioComponent and Port).

The ontology language includes a number of generic properties, e.g., subClassOf, subProperty, sameAs, which are used to represent facts that one class is a subclass of another, one property is a sub-property of another, and that two entities are “the same”. OWL axioms define the meaning of such terms mathematically. For instance, ChannelDecoder can be declared as subClassOf the RadioComponent class. Using such statements and OWL axioms, the inference engine 120 can then derive that ChannelDecoder1 is an instance of RadioComponent. The derivation of this fact can trigger further derivations since any axioms that are associated with RadioComponent are now applicable to ChannelDecoder.

While the ontology language can describe various aspects of domains and for deriving new facts from facts explicitly represented, in some embodiments, the nodes 105a-n can also use a rule language in addition to the ontology language to facilitate describing relationships in composite components and state machines. In some embodiments, the nodes 105a-n can use the rule language of BaseVISor—a forward-chaining inference engine developed by VISTOLOGY, Inc. This rule language is based on the Rete network optimized for the processing of RDF triples, and it incorporates axioms and consistency checks for the OWL 2 RL semantics.

In some embodiments, the node 105 includes an agent 115 designed and constructed to facilitate analyzing the reconfiguration request and determining whether a new protocol component is required to communicate via a new waveform or protocol associated with the reconfiguration request. In some embodiments, the agent 115 includes a cognitive agent having a cognitive architecture, such as a symbolic, connectionist or hybrid architecture. The agent 115 can be based on a set of rules.

In some embodiments, the node 105 includes an inference engine 120 designed and constructed to perform computations based on models provided by an ontology language. The cognitive agent 115 may include, communicate with, or integrate with the inference engine 120 via an API. In an illustrative example, the inference engine 120 may include a BaseVISor inference engine, and the agent 115 can integrate with the inference engine 120 via BaseVISor's Java API and through procedural attachments. The node 105a can also use the Java API to interact with the database (e.g., to assert facts and to make queries). In some embodiments, the node 105 can call this API to (re)trigger the inference engine 120. The node 105a can use procedural attachments to define new constructs in the BaseVISor rule language, to generate new resources when the rules are building an OWL model (of a composite component or a state machine), or to initiate the component query to a master node 105a-n when a rule of a slave node 105a-n detects that an unknown type of an individual has been asserted.

To reconfigure the node 105a to communicate using a new protocol in response to a request for reconfiguration, the inference engine 120 can build a complex software component for the new protocol using simpler components. In an illustrative example, the selected ontology language can include components that are descendants of the class Component. The class Component can include subclasses: BasicComponent, CompositeComponent and StateMachineComponent. These subclasses can represent components from the base ontology, components not in the base ontology that are not state machines and state machine components, respectively.

In some embodiments, the components can include software components, hardware components, firmware components or mixed hardware/firmware and software components. Components can be implemented in software, firmware or hardware. In some embodiments, the system 100 can support more than one kind of component realization. A component realization may refer to a technique of obtaining an instance of the component class. In an illustrative example, a component can include the following component realizations: a JavaClassInstance realization, which denotes the creation of the instance of the component from a Java class; a ComponentComposition, which denotes that the instance of the component is a composition of simpler objects; and a StateMachineCodeGen, which denotes that the instance of the component class obtained through this realization started as the state machine description, was then used to generate source code, and was then, in turn, compiled into a Java class, an instance of which is an instance of the component. Additionally, and in some embodiments, component realizations may include hardware and firmware realizations of the same component. For example, a component realization may provide one or more hardware resources implementing the functionality, while one or more software versions may also be provided for instances in which the hardware resource may not be sufficient or functioning properly. The inference engine 120 can determine the type of component (e.g., software, hardware, firmware, mixed) to realize or construct based on rules encoded in the node 105a. In some embodiments, implementing a component in hardware may be preferred over software implementation.

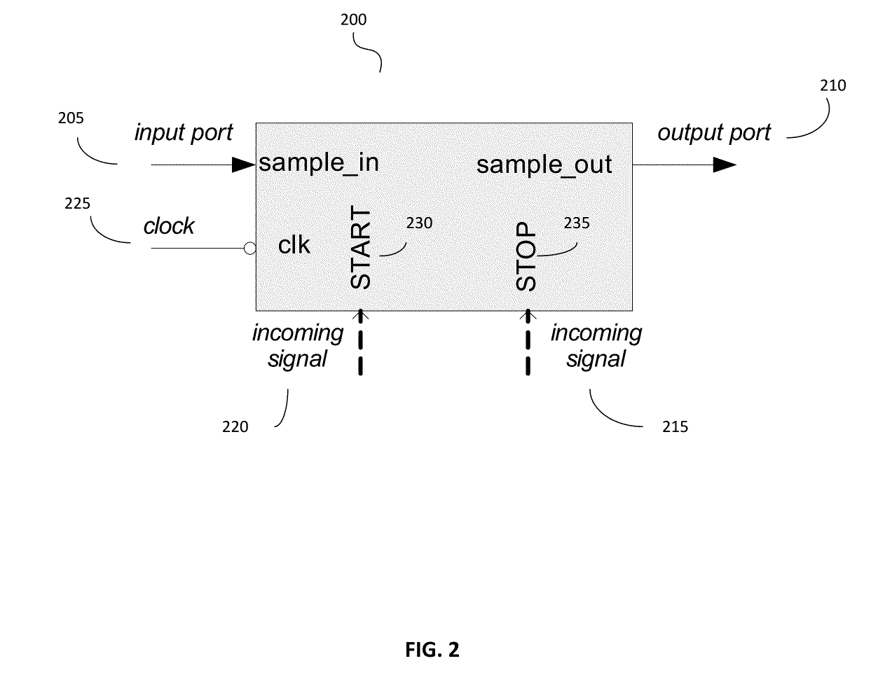

FIG. 2 is an illustration of an external interface including external inputs and outputs of an example component 200 in accordance with an embodiment. The component may be any type of component and may include a composite component or a component constructed in software, hardware, firmware, or a mix. For example, the component may be a decimator. The component can include a sample input port 205 that receives samples, a sample output port 210 that outputs samples, a clock input port 225 that receives clock input, a start input port 430 that receives an incoming start signal, and a stop input port 435 that receives an incoming stop signal. The external interface of the component 200 can be described using a structural description in an ontology language.

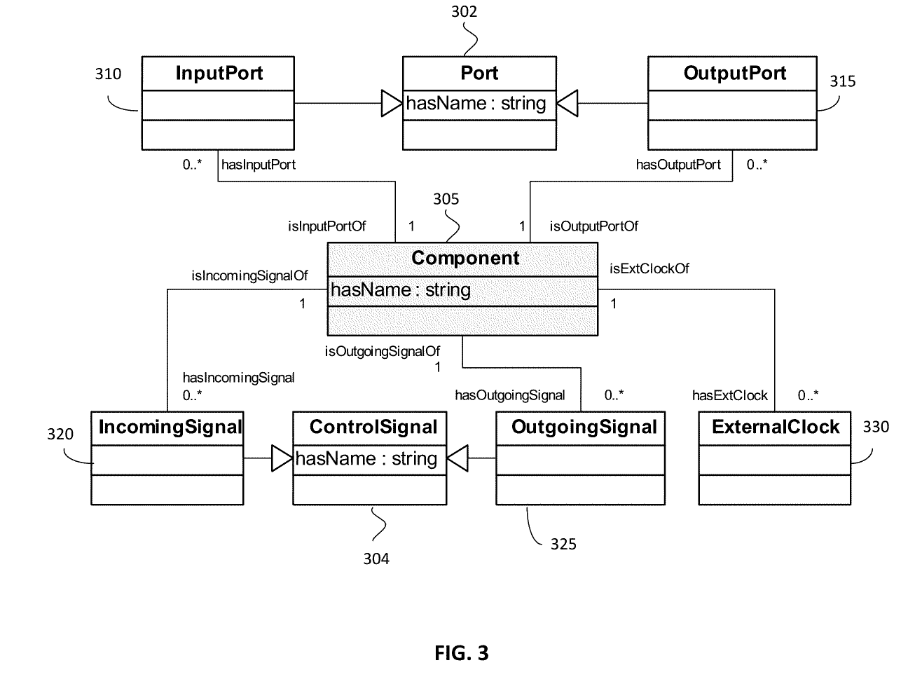

FIG. 3 illustrates data elements of a component (e.g., the component 200 shown in FIG. 2) and their connections or relationship to one another, in accordance with an embodiment. The data elements can be stored as a data structure in a database, such as database 125. Each data element can include a string that provides an identification of the data element, information about a relationship between the data element and other data elements (e.g., isOutputPortOf, isInputPortOf, isExtClockOf, etc.), and can store information associated with the data element. A component may include various types of data elements that are associated with rules and data flow requirements. The connections of the external interface of the component 200 can be determined using a description in an ontology language or rule language.

For example, the component 200 shown in FIG. 2 can correspond to a component data element 305; the input port 205 can correspond to InputPort data element 310; output port 210 can correspond to an output port data element 315; the incoming signal 220 can correspond to an IncomingSignal data element 320; the clock input 225 can correspond to the ExternalClock data element 330; the sample out 210 can correspond to the OutputPort data element 315. In some embodiments, the data structure includes an outgoing signal data element 325. The component data element 305 shown in FIG. 3 can interact with other component data elements through ports and signals and can be driven by an external clock (or clock) 330. Port data elements (e.g., 310 and 315) can be defined as a Port type 302, which can correspond to a type of interface through which data flows from one component data element to another. The port data elements 310 and 315 correspond to port type 302 that can be characterized by two features—its direction and the data type it carries. Two ports are connected if they are related through an isConnectedTo relationship, which can be stored in the data element. In some embodiments, output ports can drive more than one input port. Rules (e.g., local rules rather than rules received as part of the reconfiguration request) can be used to restrict the number of input ports that can be driven by a single output port. Ports can handle major flows of data and are configured to provide a corresponding amount of throughput.

The signals 215 and 220 shown in FIG. 2 can include messages (e.g., binary messages) sent from one component to another. The signals, for example, may provide some form of notification such as a notification about asynchronous events (e.g., START STOP). In some embodiments, ports are configured to transport, convey, transmit or other move data between components, whereas signals, which can also carry data (e.g., Boolean signals carrying Boolean data) refer to notifications of events. Signals 215 and 220 can correspond to data element 320 and 325 shown in FIG. 3, which can provide the signal to a large number of receivers. For example a reset signal in a very complex component may be received by some or all subcomponents (potentially a large number). Thus, the inference engine can generate or implement signals in hardware or firmware to facilitate providing signals to a large number of receivers. The ControlSignal 304 port type can include an IncomingSignal 320 and an OutgoingSignal 325.

The external clock data element 330 can be a source of periodical events used to pace the flow of data through synchronous components. In some embodiments, a component may include more than one external clock or may not require any clock signals at all—in this case the inputs are processed when they are asserted on the input ports.

In some embodiments, two sets of parameters may be associated with a component: instantiation parameters and run-time parameters. The inference engine 120 can use the instantiation parameter during the construction of an instance of the component. For example, if the component is implemented in an object oriented language, the instantiation parameters might be passed to a constructor routine as input parameters. In some embodiments, components might also have observable and/or adjustable run-time parameters (knobs and meters), which can be read and/or adjusted through Get and Set operations. A run-time parameter can be adjustable or can be read-only. Parameters can include a tag (a name) that is used to identify it during Get/Set operations. An example of a run-time parameter may include “fCenter”, which can be used to modify the center frequency of a waveform.

The inference engine 120 can construct or realize a component using a correct-by-construction approach. In this approach, the inference engine 120 constructs the ontological model of the waveform in a formal way. Thus, if the received description of the waveform (e.g., its descriptive and constructive rules) is correct, result generated by the inference engine 120 is correct by construction.

In some embodiments, using the correct-by-construction approach, the inference engine 120 can build an OWL model of the waveform in a single phase without having a separate stage of building the model and then proving that the model satisfies all constraints imposed by the waveform description. In some embodiments, the inference engine 120 can automatically build the model by applying rules in the inference engine 120.

In some embodiments, the inference engine 120 can realize a descendant of CompositeComponent type either as a single discrete component (if available) or as a composition of simpler components. Similarly a descendant of a StateMachineComponent type may be instantiated as a discrete component but if such a component is not available in the node 105a database 125, the inference engine 120 can use the associated description of the state machine to generate an executable component instance.

Table 1 illustrates the types of component realization:

TABLE 1
Component Realization Types

| Component | | | |
|---|---|---|---|
| realization | | Composite | State Machine |
| type | Basic-Component | Component | Component |
| discrete | Y | Y | Y |
| software | | | |
| module | | | |
| hardware or | Y | Y | Y |
| firmware | | | |
| resource | | | |
| component | | Y | |
| composition | | | |
| state | | | Y |
| machine | | | |
| generation | | | |

As shown in table 1, a basic component can be realized using a discrete software module or a hardware/firmware resource. A composite component can be realized using a discrete software module, a hardware/firmware resource or a component composition. A state Machine Component can be realized using a discrete software module, a hardware/firmware resource, or by state machine generation.

In some embodiments, the realizations can be managed by a set of classes derived from the class Realization. In an illustrative example, the following realization classes can be defined in the ontology: JavaClassInstance, ComponentComposition, and StateMachineCode Gen. The first class, JavaClassInstance, is for instantiations from Java classes. An individual of the JavaClassInstance includes the name of a JAR file and the name of a Java class that implements the component. The second realization, ComponentComposition, is for instantiations that create instances of components as a composition of simpler components. The third realization, StateMachineCodeGen, is for state machine components which can be created through on-the-fly generation of executable state machines from their ontological descriptions.

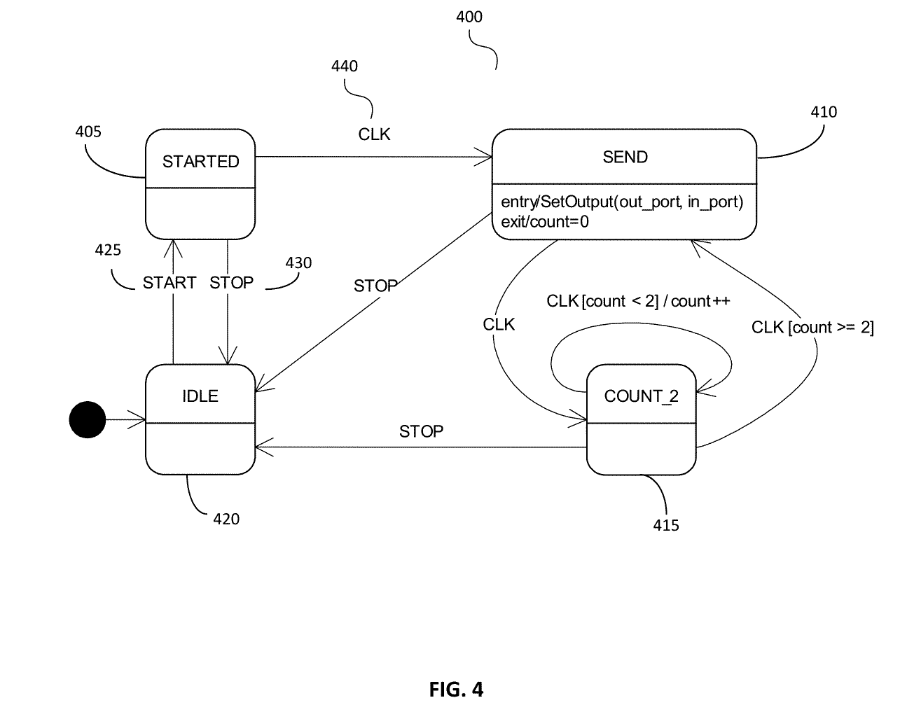

To construct or realize a state machine, the inference engine 120 uses a state machine description ontology. In some embodiments, this state machine description ontology can be based on a state transition diagram (“STD”). FIG. 2 illustrates an external interface of a decimator component, and FIG. 4 illustrates an example behavior of a decimator component using a state transition diagram.

FIG. 4 is an illustration of an example state machine transition diagram 400 in accordance with an embodiment. The state machine diagram 400 can correspond to the behavior of the component 200 shown in FIG. 2, for example. The state transition diagram 400 can include a state, transition between states, an action that is triggered by the state transition, an activity that includes a sequence of actions, and an event that triggers a state transition. In some embodiments, the state transition diagram 400 corresponds to a finite state machine. In some embodiments, the behavior associated with the state transition diagram 400 can be represented as a state transition table that identifies current states and events that caused a transition to/from states.

The example state machine diagram 400 includes multiple states such as IDLE 420, STARTED 405, SEND 410, and COUNT_2 415. A state may include or correspond to an activity. An activity can include a single action or a sequence of individual actions. For example, the SEND 410 state includes activity “SetOutput(out_port, in_port)” and “count=0”; and the COUNT_2 state 415 includes activity “count++”. In some embodiments, actions may occur on a state transition.

The state transition diagram 400 can also include events such as CLK 440, STOP 430, START 425. For example, each state can include two events—an entry and an exit. Further, an activity can be associated with each event. For example, the SEND state 410 includes activity “count=0” associated with its “exit” event. That is, when the state machine transitions out of the SEND state 410, the count will be set to 0.

The input and output used to drive the state transition diagram 400 is provided by the external interface of component 200. This data may include clock input 225; input and output ports (e.g., 205 and 210); incoming and outgoing signals (e.g., 220 and 215); definitions of events generated based on a reception of a signal, a change of the value on an input port, or a reception of a clock signal; properties that store auxiliary data for the state machine to work (e.g., similar to local variables in programming languages), parameters that support Get and Set operations (e.g., similar to run-time parameters of regular components).

For example, in the illustration of the decimator state transition diagram shown in FIG. 4, the decimator may be in an initial state corresponding to IDLE 420. While in state 405, the component can then receive a START signal and transition to state 405. The decimator component may receive a STOP signal which can cause the decimator to deactivate and transition back to the IDLE state 420. When active, the decimator stays in the loop between the SEND (410) and the COUNT_2 state (415). The decimator reads a value from the input port sample_in and writes this value to the output port sample_out when it enters the state SEND (410), which can occur every fourth clock event (CLK).

A state can represent a fundamental element of the state machine, and is represented by individuals of type fsm.State. A state may represent a stage in the behavior pattern of a component. For example, a state may define OnEnter and OnExit action sequences which are executed when the state machine transitions into and out of the state, respectively. The definition of a state also references the individuals representing the transitions that originate in this state. In some embodiments, the state may include properties, such as doAction, isFinal, and islnitial. The properties may have various data types. For example, one or more properties may be Boolean data type properties (e.g., isFinal and islnitial). The initial state may refer to a state corresponding to when an object is first created, and a final state may correspond to a state from which no further transitions exist. A doAction can correspond to a state transition that trigger an action or a sequence of actions.

The following is an illustrative example of pseudo code for the state STARTED 405 using BaseVISOR syntax:

```
<obr:fsm.hasState variable=“_Ind.STARTED”>
  <rdf:type resource=“owl:NamedIndividual”/>
  <rdf:type resource=“obr:fsm.State”/>
  <obr:hasName datatype=“xsd:string”>STARTED
  </obr:hasName>
  <obr:fsm.hasTransition variable=
    “_Ind.STARTED.Transition.0”>
    <rdf:type resource=“owl:NamedIndividual”/>
    <rdf:type resource=“obr:fsm.Transition”/>
    <obr:fsm.triggeredBy variable=“_Ind.Event.CLK”/>
    <obr:fsm.hasTarget variable=“_Ind.SEND”/>
  </obr:fsm.hasTransition>
  <obr:fsm.hasTransition
    variable=“_Ind.STARTED.Transition.1”>
    <rdf:type resource=“owl:NamedIndividual”/>
    <rdf:type resource=“obr:fsm.Transition”/>
    <obr:fsm.triggeredBy variable=“_Ind.Event.STOP”/>
    <obr:fsm.hasTarget variable=“_Ind.IDLE”/>
    </obr:fsm.hasTransition>
</obr:fsm.hasState>
```

Transitions can be represented by individuals of the class fsm.Transition. A transition is related to its originating state through the fsm.hasTransition property and its description includes the target state and the event that triggers it. A transition may be guarded by a constraint (fsm.Constraint), which is an expression that evaluates to a logical true/false value (e.g., “CLK [count<2]”). In addition to a guard, the transition may also define a sequence of actions to be taken when the transition is executed. The transition actions can be executed after the OnExit action sequence of the originating state and before the OnEnter sequence of the target state.

An expression (fsm.Expression) is an arbitrary statement that evaluates to a single value. In addition to their use as guards, expressions are used as parameters to actions and API functions. The other types of expressions include API function calls, arithmetical operations, bit operations, values read from input ports and constant values. In the illustrative example of FIG. 4, expressions may include “CLK [count<2]” or “CLK [count>=2]”.

Events trigger transitions between states. Three subclasses of fsm.Event correspond to three sources of events—clocks, signals and changes of input port values.

An action (fsm.Action) represents an executable statement. A collection of actions executed together can be referred to as an activity. In some embodiments, an activity includes an action sequence, which can include an ordered list of individual actions. The state machine ontology can support multiple types of actions including, for example, emitting a signal, setting output port to a value of an expression, setting a property (local variable) to a value of an expression, etc.

Properties are similar to local variables in the programming languages and may be used as data buffers, counters, flags, etc. State machine parameters may be used to access and possibly adjust the internal data values in a state machine. The definition of a parameter can include an action sequence for a Get operation. In some embodiments, the parameter may also include an action sequence for a Set operation if the parameter can be adjusted. If a Set action sequence is defined, the parameter definition may also include a validation constraint.

In some embodiments, the state machine related part of the base ontology may not include a hierarchy in the definitions of state machines. In some embodiments, the state machine part of the base ontology can include definitions of hierarchical state machines (i.e. state machines with sub-state machines). State machines with hierarchical definitions can provide potential for the reuse of the state machine definitions, which could reduce the overhead related to transferring state machine definitions.

Thus, the inference engine 120 can use the description of the component to create such a component. For example, when the node 105a receives a request from another node to create an individual of a specific class, the node 105a can also receive the description of how to create such a component. A description of a component of a specific class can include an external description and an internal description.

The external description lists all the ports, signals, clock inputs, instantiation parameters and their types. This description contains enough information to instantiate the component and connect it to other components, but may not provide information on its internal structure. For BasicComponents (i.e. components in the base ontology that are not decomposable any further) this description may suffice.

An internal description augments the external description with information on how to build the component. The internal description is a part of the component's realization definition—it contains either the description of the component composition (for components derived from CompositeComponent) or the description of the state machine (in case of descendants of StateMachineComponent).

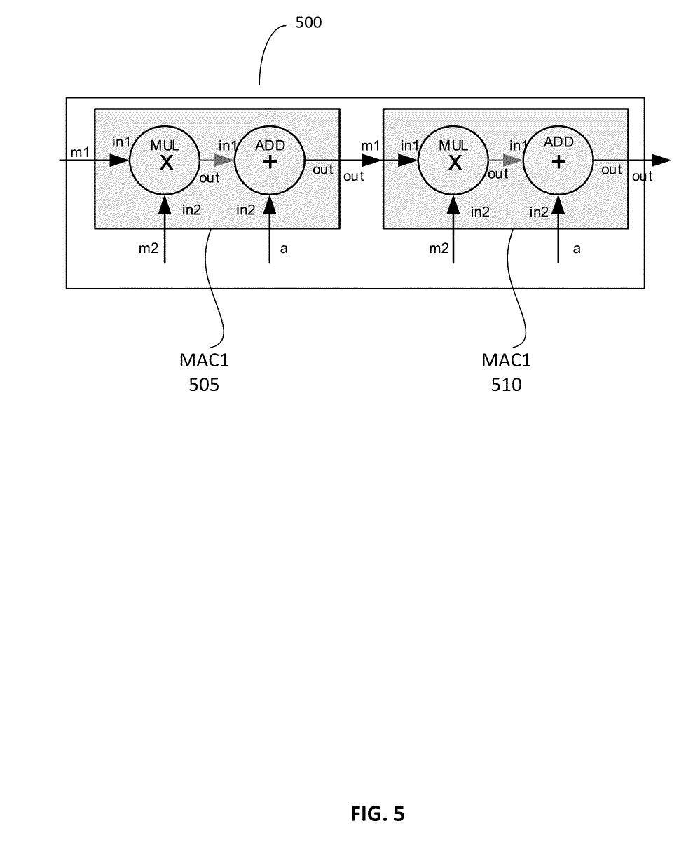

In some cases, a composite component (e.g. an instance of a composite component class) consists of a number of subcomponents of the same type that are connected together in a specific way. In an illustrative example shown in FIG. 5, the component 500 includes a cascade of two multiply-accumulate (MAC) subcomponents (505 and 510). Each MAC further includes subcomponents for multiply (“MUL”) and addition (“ADD”), and input ports (in1 and in2) and output ports (out). Thus, system 100 can express the description of component classes in a manner that differentiates multiple instances of a component using a tag (or label). In this case, node can describe the two instances of the MAC using tag ‘MAC1’ and ‘MAC2’, and further describe that there is a connection between the output of the one of these instances (MAC1) and an input of the other one (MAC2). The class description can express relationships between different components of the same type without referring to concrete OWL individuals.

In some embodiments, the description received by the node 105a (or sent from another node 105b-n) includes tags (or labels) associated with individuals of the description. The tags can be unique at a given level of scope—e.g. some or all subcomponents may include unique tags, all ports of the specific component can be unique, etc. The tags can be used to differentiate between individuals referred to in OWL expressions. The descriptions of the relationships can be written as rules in which the tags are used to select the appropriate individuals and then assert the relationship. The following is an illustrative example of pseudo code of a rule describing a connection between the output of the multiplier and an input of the adder in MAC:

If the specified individual is of type MAC and if:
it has a subcomponent with a tag ‘MUL’ and
this subcomponent has an output port with a tag ‘o’ (the matched port's resource is assigned to the rule variable ‘_outPort’) and
if it has a subcomponent with a tag ‘ADD’ and
this subcomponent has an input port with a tag ‘a1’ (the matched port's resource is assigned to the rule variable ‘_inPort’)

then assert:
‘_outPort’ drives ‘_inPort’

Similar rules can be used to describe other relationships in the component (e.g. signal connections, clock connections, etc.).

The inference engine 120, in the process of this component construction, asserts the two OWL individuals representing two instances of MAC. A label (tag) ‘MAC1’ is associated with one of these individuals and the label ‘MAC2’ with the other. An example of the rule that connects the output ‘out’ of the component labeled ‘MAC1’ with the input ‘m1’ of the component labeled ‘MAC2’ might look like the following:

If:
there is a subcomponent of the class MAC with a tag ‘MAC1’ and
this subcomponent has an output port with a tag ‘out’ (the matched port's resource is assigned to the rule variable ‘_out_port’) and
there is a subcomponent of the class MAC with a tag ‘MAC2’ and
this subcomponent has an input port with a tag ‘m1’ (the matched port's resource is assigned to the rule variable ‘_in_port’)

then:
assert ‘_out_port’ drives ‘_in_port’

Thus, in some embodiments, the internal description can include the definitions of subcomponents, connections between them and the connections between external ports and signals of the ports and signals of subcomponents. The tags of the external ports and signals can be different than the tags of ports/signals they are internally connected to.

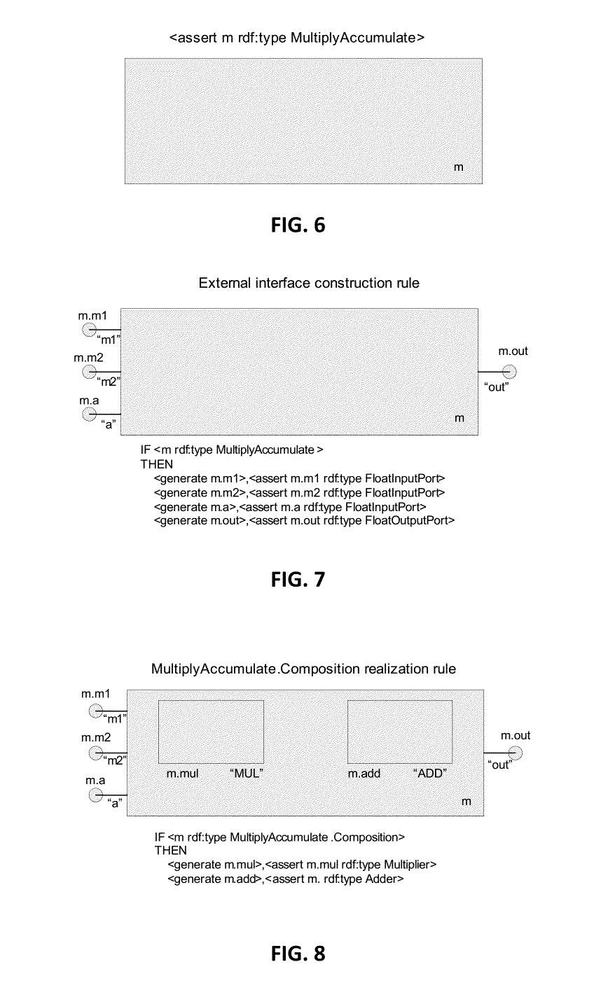

Responsive to a reconfiguration request to use an unknown protocol, the node 105a can construct the new component as illustrated in FIGS. 6 through 10, which is illustrates an embodiment of a forward-chaining inference engine. Reconfiguration starts when one of the nodes 105b-n sends a request to node 105a to use a particular waveform (i.e. to instantiate and put online an instance of the specific software component implementing such waveform). In response to this request, the receiving node creates a new OWL individual, adds to its knowledge base an assertion that this individual is rdf:type of the requested component type and invokes the inference engine 120.

If the receiving node 105a knows the requested component type, the inference engine 120 infers from the component's realization rules all facts necessary for the creation of an instance of this component type. At the later stage of the reconfiguration process these facts are used to create an actual instance of the component.

However, if the node 105a is not familiar with the requested component, the node 105a can send a query to another node or computing device (e.g., the node 105b-n that sent the reconfiguration request or some other computing device that may have access to a description of a protocol associated with the request for reconfiguration). For example, the node 105a (e.g., via inference engine 120) can match a rule for unknown classes that was sent along with the component description. This rule executes a procedural attachment, which sends a query to the other node requesting relevant information about the component. After the description of the component is transferred from the other node, the new facts are asserted in the knowledge base and the new rules are added to the database 125 (e.g., the local knowledge having a local rule set). In some embodiments, the first node may continue to obtain information used to construct the second protocol component via a recurrent query-response exchange between the second node and the first node.

After receiving the description, the node 105a may again call the inference engine 210. This time, when the inference engine 120 processes the original assertion that triggered the component query, the node 105a determines that knowledge base 125 of node 105a includes both the external and internal description of the component. Therefore, the description rules can automatically generate OWL individuals for all internal and external elements of the composite component based on the external and internal description stored in the database 125. The presence of these individuals in turn triggers other rules that define connections and other relationships among these individuals effectively constructing the whole model of the composite component.

FIG. 6 illustrates a first stage of construction of a multiply accumulate component that performs the following function: out=a+m1*m2. The node 105a can start the construction process by creating an OWL individual (e.g. m) and assert that this individual is of type MultiplyAccumulate. As illustrated in FIG. 7, the node 105a can then assert that the individual is of a specific component type to trigger an external interface construction rule for this type. Triggering the corresponding external interface construction rules creates and asserts OWL individuals for external interfaces (ports, signals etc.). For example, ports may include FloatInputPort, and FloatOutPut port. In some embodiments, the following illustrative rule can be used to construct the external interface:

IF<m rdf.type MultiplyAccumulate>

THEN
<generate m.m1>, <assert m.m1 rdf.type FloatInputPort>
<generate m.m2>, <assert M.m2 rdf.type FloatInputPort>
<generate m.a>, <assert m.a rdf.type FloatInputPort>
<generate m.out>, <assert m.out rdf.type FloatOutputPort>

Using this code or other similar code, for example, the node 105a can generate the following external interface for component m: inputs m.m1 (“m1”), m.m2 (“m2”), m.a (“a”); and output m.out (“out”).

The node 105a can then execute a composition realization rule as shown in FIG. 8. In this composite component, the node 105a creates and asserts OWL individuals for subcomponents m.mul multiplier “MUL” and m.add adder “ADD”. The following exemplary rule illustrates how the composition is realized by node 105a:

IF<m rdf:type MultiplyAccumulate.Composition>

THEN
<generate m.mul>, <assert m.mul rdf:type Multiplier>
<generate m.add>, <assert m.add rdf:type Adder>

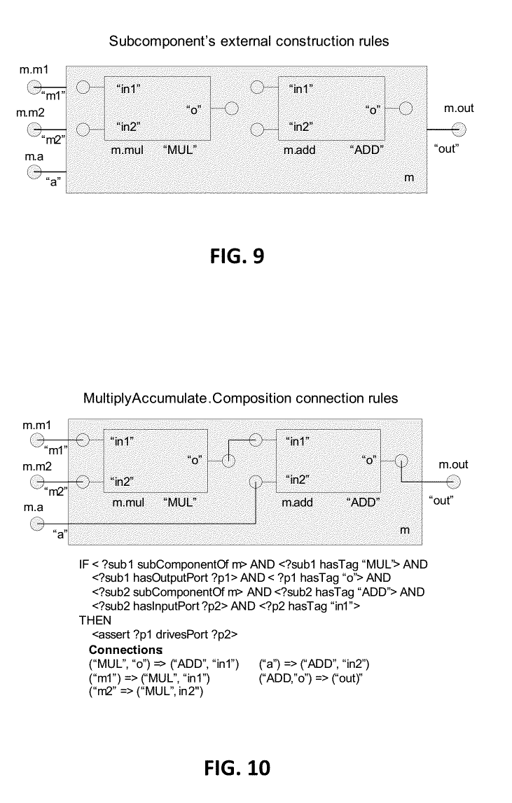

The node 105a can then construct the external interface of the subcomponents as shown in FIG. 9. When the rule to construct the external interface is triggered, the node 105a creates OWL individuals representing external interfaces of subcomponents. For example, the external interfaces for both the “MUL” and “ADD” subcomponents include input ports “in1” and “in2” and output port “o”.

Once the external interface of the subcomponents are created, the node 105a can connect the interface pairs that are supposed to be connected, as shown in FIG. 10. The node 105a connects the interface pairs according to composition connection rules for Multiply Accumulate as follows: input “m1” of composite component “m” is connected to “in1” of subcomponent “MUL”; input “m2” of composite component “m” is connected to “in2” of subcomponent “MUL”; output “o” of subcomponent “MUL” is connected to input “in1” of subcomponent “ADD”; input “a” of composite component “m” is connected to input “in2” of subcomponent “ADD”; and output “o” of subcomponent “ADD” is connected to output “out” of composite component “m”. The following illustrative connection rule can be used by node 105a to connect the interface pairs:

| | |
|---|---|
| IF | <sub1 subComponentOf m> AND <sub1 hasTag “MUL”> AND |
| | <sub1 hasOutputPort p1> AND <p1 hasTag “o”> AND |
| | <sub2 subComponentOf m> AND <sub2 hasTag “ADD”> AND |
| | <sub2 hasInputPort p2> AND <p2 hasTag “in1”> |

THEN

<assert p1 drivesPort p2>
Connections:
(“MUL”, “o”) => (ADD”, “in1”)
(“m1”) => (“MUL”, “in1”)
(“m2”) => (“MUL”, “in2”)
(“a”) => (“ADD”, “in2”)
(“ADD”, “o”) => (“out”)

In some embodiments, a further realization rule for subcomponent “MUL” or “ADD” may be triggered. If any of the subcomponents need to be composed, these rules create OWL individuals for their subcomponents and the node 105a can construct the subcomponents recursively at deeper and deeper levels until all subcomponents are available without further composition. For example, the node 105a may recursively repeat the stages of asserting OWL individuals for a subcomponent, construct an external interface of the subcomponent, connect the interface pairs, and again trigger any realization rules for the subcomponent.

In the correct-by-construction approach, in some embodiments, the node 105a executes the initial assertion of the fact that the individual “m” is rdf:type MultiplyAccumulate, and the remaining actions may be consequences of this single fact, which the inference engine 120 automatically infers from the initial fact and the facts and rules describing MultiplyAccumulate.

After the node 105a constructs a model of the waveform, the node 105a can map the OWL individuals representing components in the model into actual instances of software and/or hardware components and then make the connections between them according to the object properties representing connections in the model. After the mapping and connection process is done the, node 105a can put the newly created waveform into service.

In some embodiments, the node 105a can also build a state machine from its ontological description in a similar manner. The node 105a can build the OWL model of the state machine automatically through asserted facts and rules. The node 105a may employ various techniques to translate the OWL model of the state machine into a component. For example, and in some embodiments, the node 105a can use a two-stage process to building state machines. In the first stage, the node 105a translates the OWL constructs into related Java constructs buffered in memory. In the second stage, the node 105a compiles the buffered Java source code in memory into a binary class that is used to create an instance of the state machine component.

Table 2 illustrates an example mapping of state machine model elements into Java source code constructs. While Java is used in this example, the node 105a can also be configured to use other programming languages.

TABLE 2
State machine element mapping

| SM Element | Java Code Mapping |
|---|---|
| State | class |
| State OnEnter/OnExit Actions | OnEnter( )/OnExit( ) methods |
| Transition | class |
| Transition Guard | conditional expression |
| Transition Actions | OnTransition( ) method |
| Event | event notification method |
| Port | Port object + data member |
| Property | data member |
| Run-time parameter | data member |

As illustrated in Table 2, the state machine element “State” maps to Java Code Mapping “class”; the state machine element “State OnEnter/OnExit Actions” maps to Java Code “OnEnter( )OnExit( ) methods”; the state machine element “Transition” maps to Java Code “class”; the state machine element “Transition Guard” maps to Java Code “conditional expression”; the state machine element “Transition Actions” maps to Java Code “OnTransition( ) method”; the state machine element “Event” maps to Java Code “event notification method”; the state machine element “Port” maps to Java Code “Port object+data member”; the state machine element “Property” maps to Java Code “data member”; and the state machine element “Run-time parameter” maps to Java Code “data member”.

The node 105a, therefore, can automatically construct an OWL model of a composite component or a state machine. The node employs formal reasoning of the forward-chaining inference engine 120. Using this approach, if the description rules and facts are correct, the resulting model is also correct. The working instance of the composite component or state machine is a one-to-one mapping of OWL individuals and relationships into components and connections (or Java constructs in case of the state machine descriptions). Once the description of a component is transferred and integrated in the local knowledge base of the node 105a, the component can be used to create other instances for this component type. Thus, the node 105a can effectively acquire facts about a previously unknown component and later apply the acquired knowledge as needed.

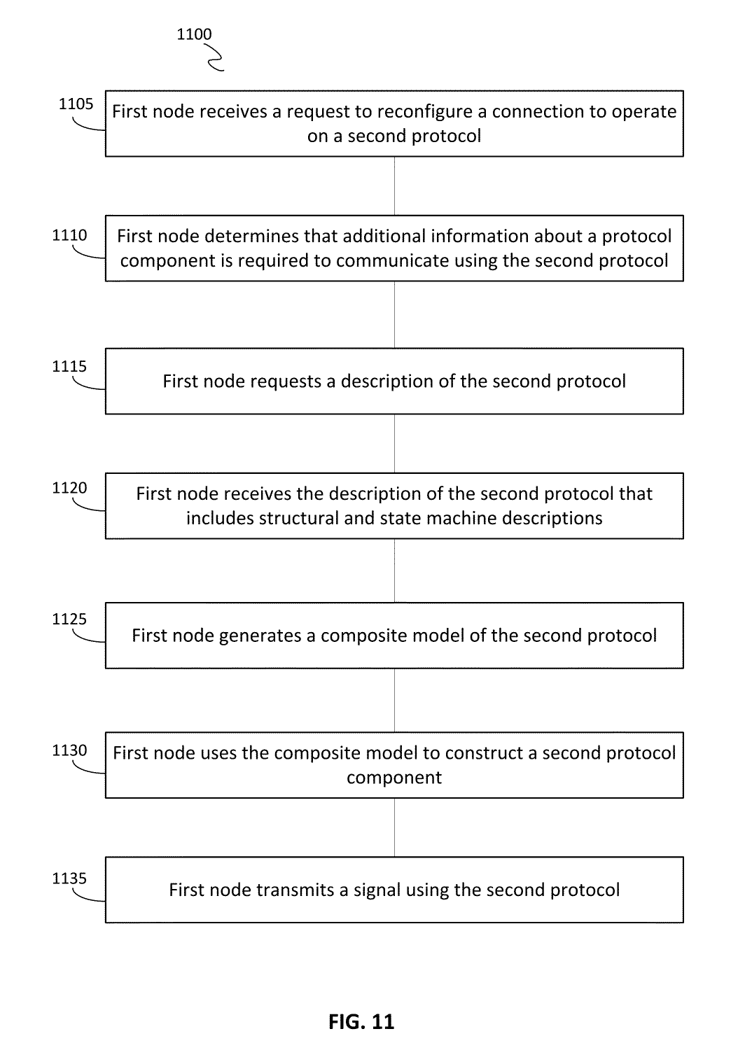

FIG. 11 is a flow chart illustrating an example method 1100 for reconfiguring a connection protocol in accordance with an embodiment. In brief overview, the method 1100 includes the first node receiving a request to reconfigure a connection to operate on a second protocol (1105). The method 1100 can include the first node determining that additional information about a protocol component is required to communicate using the second protocol (1110). The method 1100 can include the first node requesting a description of the second protocol (1115). The method 1100 can include the first node receiving the description of the second protocol that includes structural and state machine descriptions (1120). The method 1100 can include the first node generating a composite model of the second protocol (1125). The method 1100 can include the first node using the composite model to construct a second protocol component (1130). The method 1100 can include the first node transmitting a signal using the second protocol (1135).

The method 1100 may be performed by the systems, nodes, components, computing devices illustrated in FIGS. 1-10. For example, the first node may correspond to node 105a and second node may correspond to one of nodes 105b-n of system 100 illustrated in FIG. 1.

In further detail, the method 1100 includes the first node receiving a request to reconfigure a connection to operate on a second protocol (1105). The first node can receive the request via a communication channel having a data link or a control link. In some embodiments, the first node receives the request via a wireless connection from a second node. In some embodiments, the connection between the first node and second node may have been previously established. The request to reconfigure the connection may include information about a new protocol to be used for the connection. The new protocol or waveform may be known or unknown to the first node, but can be ultimately represented using a base ontology shared between the first node and the second node.

In some embodiments, the reconfiguration request can be sent by the second node responsive to a change in circumstances in the connection or environment, based on a rule, an event, or responsive to user input. In some implementations, the reconfiguration request can be sent by the second node to improve or change connectivity, gain, security (e.g., encryption or authentication), battery conservation, throughput, signal strength, audio quality, bandwidth, interference, etc. In some embodiments, a node may monitor a connection status and send a reconfiguration request response to the connection status. For example, if a battery power of a node falls below a threshold battery power percentage or remaining talk time, the node may send a request to switch to a protocol that may conserve batter power, but have a lower audio quality (this may be a satisfactory trade-off to increase talk time).

The method 1100 can include the first node determining that additional information about a protocol component is required to communicate using the second protocol (1110). In some embodiments, an agent of the first node can determine that the component necessary to use the second protocol does not exist in a database of the first node or has not been previously used by the first node. For example, the database may include a data structure storing a list of available components, and the agent may parse the list to determine whether a second protocol component exists. In some embodiments, an inference engine of the first node can begin to construct the second component using information received as part of the request, and determine that the first node is missing a component or subcomponent associated with the second protocol.

The method 1100 can include the first node requesting a description of the second protocol (1115). The first node can request the description of the second protocol responsive to determining the first node does not include sufficient information to create the second protocol component. The request for the description can be in the form of a query. In some embodiments, the initial request received by the first node can include information to facilitate generating a query by the first node for additional information, such as an indication of the second protocol component for which the description is requested.

The method 1100 can include the first node receiving the description of the second protocol that includes structural and state machine descriptions (1120). The structural and state machine descriptions of the second protocol can include descriptions in an ontology language, such as OWL, and a rule language, such as BaseVISor. The description can describe components, interfaces, states, transitions, events, actions, etc. of the second protocol. For example, the structural description can include instances of components, ports and signals, while the state machined description can include instances of states, transitions and guards.

The method 1100 can include the first node generating a composite model of the second protocol (1125). In some embodiments, an inference engine of the first node generates the composite model. The first node can generate the composite model using the structural and state machine descriptions provided in the ontology language and rules. As described with reference to FIGS. 1-10, the first node can generate the composite model by instantiating the described component or subcomponent and executing rules to generate external interfaces and connect the interfaces. Once all the subcomponents are constructed and the interfaces are properly connected, the composite component or composite model can be stored in a database of the first node for later use or further processing.

In some embodiments, during construction of the composite model, the first node can determine that additional protocol component descriptions may be required to construct the component. For example, a required subcomponent or sub-sub component may be unknown to the first node. Based on this determination, the first node may then again request a description of this unknown subcomponent from the second node. This request may in the form of a query and include an indication of the subcomponent for which a description is requested (e.g., “what is that waveform?”). In some embodiments, this second description may be a lower level description because it is a description of a subcomponent of a component for which a description was already provided. For example, the first node initially receives a description of a component MultiplyAccumulate. The first node, while generating the sub components “MUL” and “ADD”, may determine that the first node does not have a description of the “ADD” subcomponent, and then generate a request for a description of the “ADD” subcomponent. Thus, the second node may provide a description of the “ADD” subcomponent using a lower level ontology description (e.g., a description of MultiplyAccumulte is higher level and includes subcomponents “MUL” and “ADD”, whereas a description of “ADD” may include lower level sub-components). In some embodiments, the first node may continue to obtain information used to construct the second protocol component via a recurrent query-response exchange between the second node and the first node.

In some embodiments, the composite model can include multiple state machines. In some embodiments, state machines may be nested where a state machine includes one or more states that are internally also state machines.

The method 1100 can include the first node using the composite model to construct a second protocol component (1130). In some embodiments, each ontology individual (e.g., OWL individual) of the composite module is mapped to an actual software, hardware or firmware component. As the first node includes information on software, hardware or firmware components associated with the component model, the first node can map the composite model to its corresponding software, hardware and firmware components. In some implementations, the base ontology may include information that facilitates mapping the composite model to corresponding components.

After the composite model of the second protocol component is mapped to corresponding components in software, hardware and firmware, the method 1100 can include the first node transmitting a signal using the second protocol (1135). In some embodiments, the second protocol component can be stored in a database of the first node for later use.

In some embodiments, the nodes can provide versioning of the software. For example, versioning may be performed for the middleware that implements the infrastructure of the components (ports, signals etc.). The versioning may also be extended to the descriptions of software components and state machines using, for example, a pair (name, version). This may facilitate maintaining a logical relationship between different versions of the descriptions, which facilitates providing incremental updates. Providing incremental updates to a waveform can reduce the waveform description overhead. For example, if a new version of the state machine definition is required and the previous version is already available, the second node may transmit the delta (the incremental change), rather than the full description of the state machine.

Thus, systems and methods of the present disclosure provide for reconfiguration of a waveform. In some embodiments, the two nodes have an established communications channel therebetween, the two nodes share the same base SDR ontology, which is the lowest common denominator for the SDR-related knowledge, and each node includes a cognitive agent that is able to acquire knowledge and can reason about the node's internal status and the facts in the knowledge base.

The node can include a communication device or cognitive radio having an SDR. The SDR part of the radio's software provides the communications services to the user, where the bulk of data sent across a communications channel can include data messages from higher layers of protocol (data link), while signaling messages are exchanged via the control link.

Reconfiguration involves first receiving a reconfigure request from a second node. If the first node knows the requested waveform it executes the request and switches to this waveform. If first node does not know the waveform, the first node responds with a request for its description. A node that initiated the request for reconfiguration sends the description of the waveform, which can be represented in OWL/Rules and may contain either a description of the component structure or a specification of the state machine or both. The first node can verify whether it knows all the components in the description. If not, the first node can send a request for descriptions for all components it does not know. This process can be repeated until all unknown components are decomposed to simpler components the first node (or receiving node) knows.

The first node then builds a model of the composite component out of OWL individuals. Based on the model, the first node instantiates some software components from the local component library. State machines are generated from their descriptions. The first node assembles the waveform component by connecting the components as described in the OWL model. The first node, having assembled the waveform component, constructs the waveform and can put it into service.

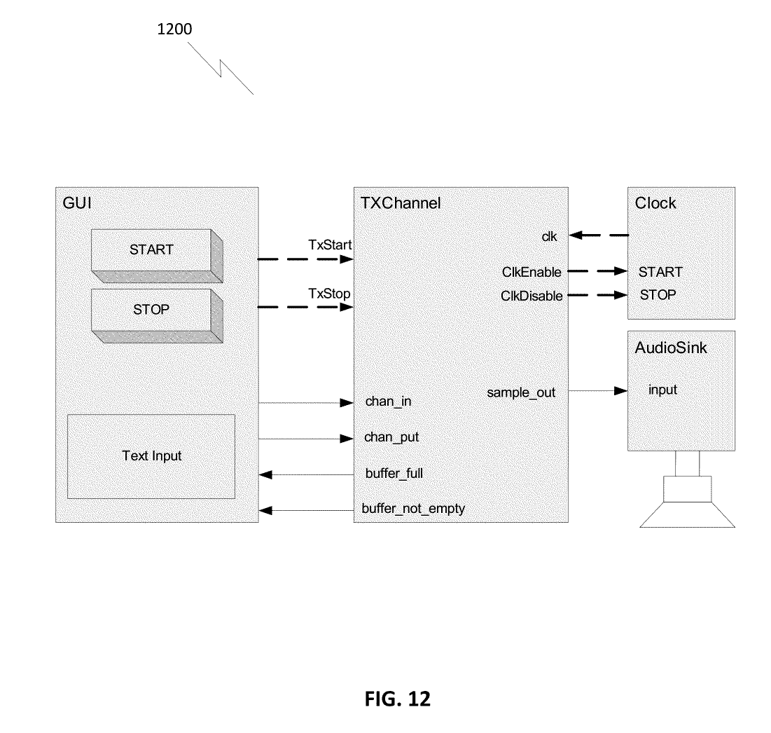

FIG. 12 illustrates a block diagram for an example test system 1200 to facilitate reconfiguring a connection protocol in accordance with an embodiment. In some embodiments, the system 1200 includes a graphical user interface (“GUI”) that is communicatively coupled to a TX Channel. The TX Channel is communicatively coupled to a Clock and an AudioSink. The GUI receives start, stop and text input. The TX channel receives start signals, stop signals, and channel input from the GUI, and transmits a buffer full or buffer not empty signal to the GUI. The TX Channel can receive clock input from the clock, and transmit a clock enable/disable signal back to the clock. The TX Channel can output samples to an audiosink, such as a speaker.

In some embodiments, the system 1200 can be implemented using a programming language, such as Java. The system 1200 can include two processes communicating with each other over a network. A first process functions as a master node that initiates the reconfiguration request and responds to queries for component descriptions. A second process acts as a slave node that receives reconfiguration requests, sends component queries to the master as needed and then integrates the newly acquired knowledge of component descriptions into the local knowledge base. The slave node can implement the middleware responsible for generating state machines and assembling composite components from their ontological descriptions.

In system 1200, both nodes can use BaseVISor as their inference engine. BaseVISor can integrate with the rest of the cognitive agent through BaseVISor's Java API and through procedural attachments. The Java API is used primarily to interact with the fact database i.e. to assert facts and to make queries. The API is also called when the inference process needs to be (re)triggered. Procedural attachments are used to define new constructs in the BaseVISor rule language; in the experimental system they are used for two purposes—to generate new resources when the rules are building an OWL model (of a composite component or a state machine) and to initiate the component query to the master node when a rule detects that an unknown type of an individual has been asserted.

The GUI of system 1200 generates the events TxStart and TxStop that start and stop the waveform under test via TXChannel. A text input panel in the GUI receives textual messages that are passed onto the waveform as the payload data. The waveform TXChannel generates ClkEnable and ClkDisable signals that control the software clock. The output of the waveform is connected to the input of the AudioSink component that drives the computer's soundcard. The audio output from the soundcard is monitored by an application that receives and decodes waveforms, such as a digital modem.

In this example, the waveforms (or protocols) may include BPSK31, QPSK31 and RTTY. The system 1200 may implement the same or different external connections for these waveforms. In some embodiments, TXChannel shown in FIG. 12 can implement all three waveforms using the same external connections, such as the same sources and sinks of samples as well as the control inputs remain the same. In some embodiments, the three example waveforms can be implemented as discrete software components ready to be instantiated, composite component descriptions, or the slave node may send query for additional information.

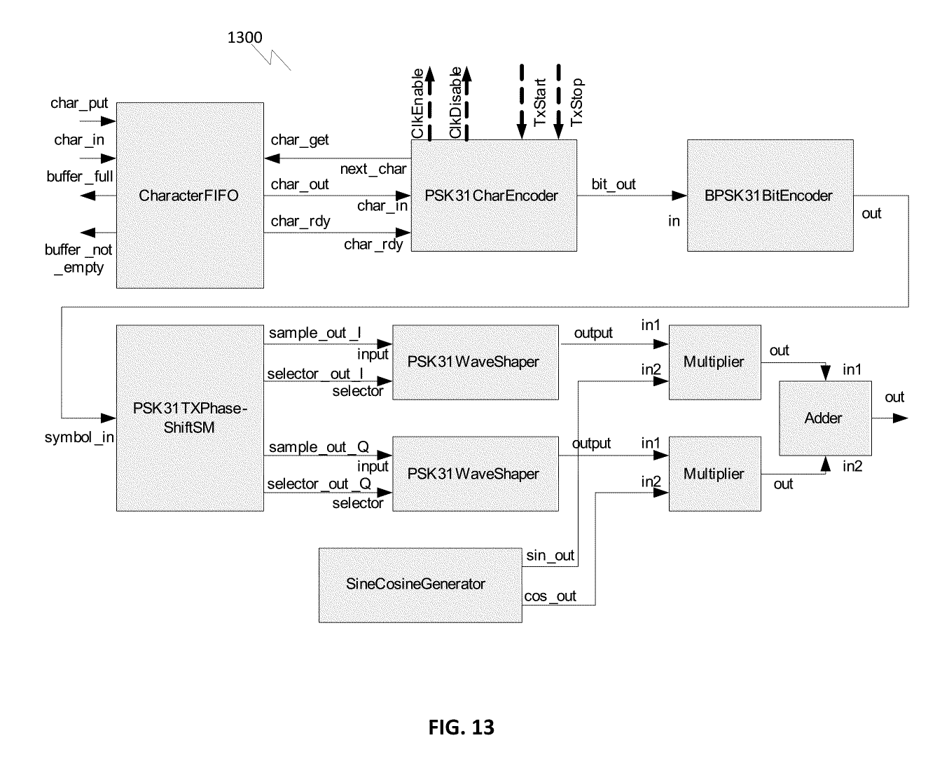

FIG. 13 illustrates a waveform decomposition 1300 of a BPSK31 TXChannel waveform in a receiving (or slave) node, in accordance with an embodiment. In some embodiments, the receiving node knows all the components in waveform decomposition 1300 such that the receiving node does not have to make further queries for additional information. In some embodiments, a plurality of queries may have been in order to construct the waveform decomposition 1300. In brief overview, the waveform decomposition 1300 includes a first in, first out (“FIFO”) character buffer; a phase shift keying, 31 baud (“PSK31”) character encoder; a binary phase shift keying, 31 baud (“BPSK31”) bit encoder; a PSK31 TX phase-shift state machine; a plurality of PSK31 Wave Shapers; a Sine Cosine Generator; a plurality of Multipliers and an Adder. Each of these components may include discrete software components, subcomponents, software, hardware or firmware.

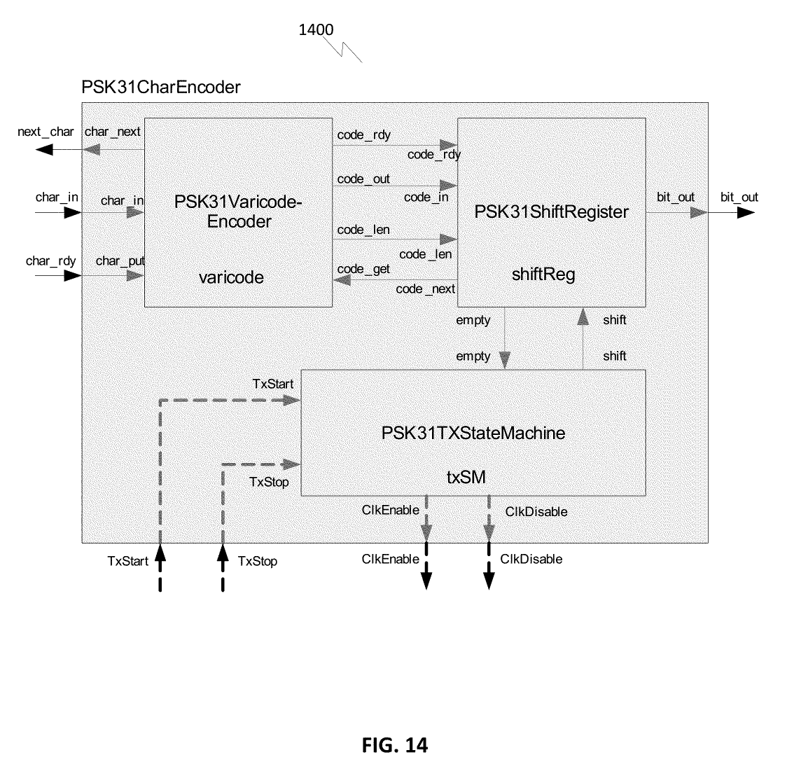

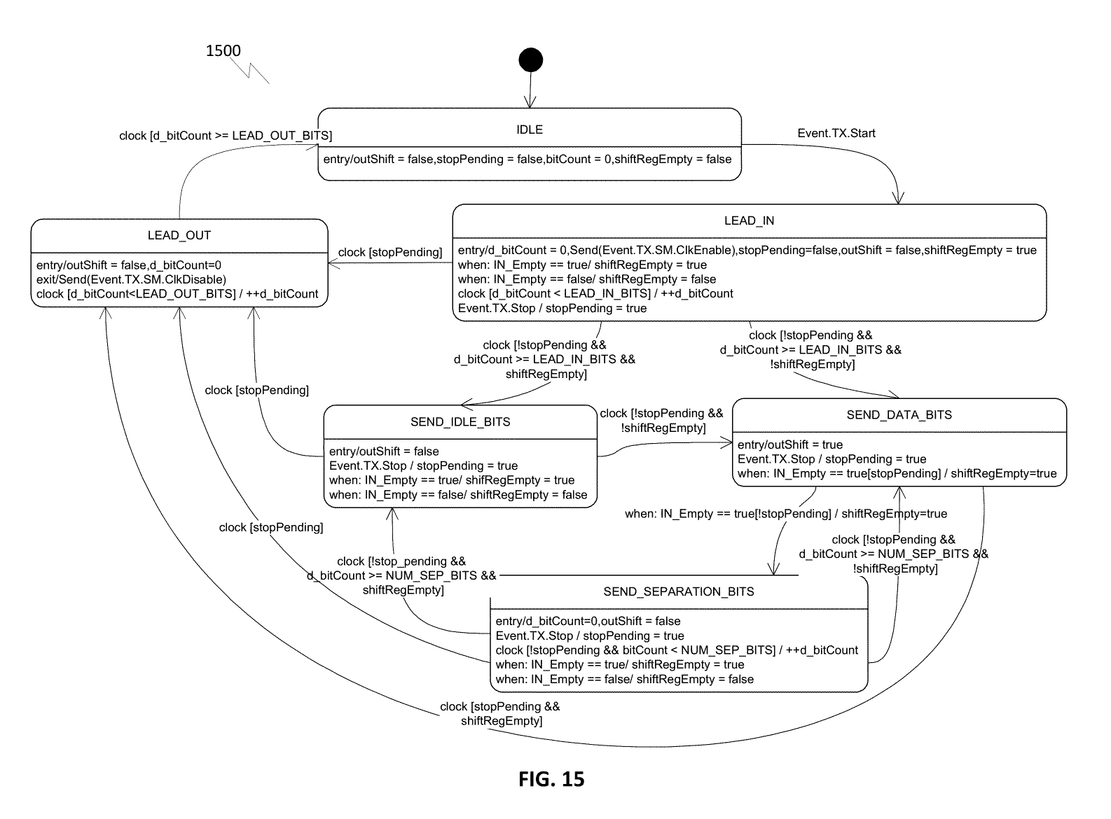

In some embodiments, the BPSK31TXChannel and QPSK31TXChannel can both use PSK31CharEncoder. In some embodiments, the PSK31CharEncoder can be implemented as a discrete software component and include a component composition, as shown in FIG. 14. PSK31TxStateMachine can be implemented as a component discrete software component as shown in FIG. 14, and include a description of its state machine illustrated in FIG. 15.

For example, the illustration of the PSK31CharEncoder component 1400 is shown in FIG. 14 Error! Reference source not found. includes external ports and signals of PSK31CharEncoder that are defined in its external description. The internal description can include the definitions of subcomponents, connections between them and the connections between external ports and signals of the ports and signals of subcomponents. The tags of the external ports and signals can be different than the tags of ports/signals they are internally connected to.

FIG. 14 illustrates an example state transition diagram 1500 for a PSK31TxStateMachine, in accordance with an embodiment. The state transition diagram 1400 can represent the behavior of a PSK31TXCharEncoder component and can be constructed using a description provided in an ontology language and rule language.

Thus, and in some embodiments, the systems and methods disclosed herein can operate in the following scenarios: when the whole waveform is available as a discrete software component; when the waveform component is not available, its description is transferred and the composite component is composed as illustrated in FIG. 13; when the waveform is not available and the PSK31CharEncoder is not available as well, the system constructs a composite PSK31CharEncoder nested within the composite component implementing the waveform; and when PSK31TxStateMachine is missing, at the end of the reconfiguration, the system can generate a state machine embedded inside a composition for PSK31CharEncoder that in turn is embedded in the waveform composition.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While various inventive embodiments have been described and illustrated herein, a variety of other means and/or structures for performing the function and/or obtaining the results and/or one or more of the advantages described herein, and each of such variations and/or modifications is deemed to be within the scope of the inventive embodiments described herein. More generally, parameters, dimensions, materials, and configurations described herein are meant to be exemplary and that the actual parameters, dimensions, materials, and/or configurations will depend upon the specific application or applications for which the inventive teachings is/are used. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Embodiments of the subject matter and the functional operations described in this specification can be implemented in various types of digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, nodes 105a-n. In some embodiments, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The term “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware or an operating system.

A computer program (also known as a program, software, software application, script, or code) can be written in any form of programming language, including compiled or interpreted languages, declarative or procedural languages, and it can be deployed in any form, including as a stand alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on nodes 105a-n.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer or nodes 105a-n can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “at least one of A and B,” as used herein in the specification and in the claims, should be understood to mean “either or both” of the elements so conjoined, i.e., elements that are conjunctively present in some cases and disjunctively present in other cases. Multiple elements listed with “at least one of” should be construed in the same fashion, i.e., “one or more” of the elements so conjoined. The phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, “or” should be understood to have the same meaning as “at least one of” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

What is claimed is:

1. A method of reconfiguring a connection protocol, comprising:
receiving, by a first node from a second node with which it communicates using a first protocol over a connection, a request to reconfigure the connection to operate on a second protocol;
determining, by an agent executing on the first node, that the first node requires a protocol component to communicate using the second protocol;
based on the determination, requesting, by the first node, a description of the second protocol;
receiving, by the first node from the second node, the description of the second protocol, the description comprising a structural description and a state machine description;
generating, by an inference engine of the first node, a composite model of the second protocol based on the structural description and the state machine description;
using, by the first node, the composite model to construct a second protocol component configured to communicate using the second protocol; and
transmitting, via the constructed second protocol component of the first node, a signal to the second node using the second protocol.

2. The method of claim 1, wherein:
the second protocol comprises at least one of an encryption protocol and an authentication protocol that are different from the first protocol.

3. The method of claim 1, further comprising:
receiving the description in an ontology language.

4. The method of claim 1, further comprising:
receiving, by the first node, rules corresponding to the description of the second protocol; and
generating the composite model based on the rules.

5. The method of claim 1, further comprising:
receiving, by the first node, the state machine description comprising a description of instances of at least one of states, transitions and guards.

6. The method of claim 1, further comprising:
receiving, by the first node, the structural description comprising instances of at least one of components, ports, and signals.

7. The method of claim 1, further comprising:
responsive to receiving the description of the second protocol, determining that the first node requires an additional protocol component to communicate using the second protocol;
based on the determination, requesting, by the first node, a second description of the additional component; and
receiving, by the first node, the second description corresponding to the additional component, the second description being lower level than the description.

8. The method of claim 1, further comprising:
obtaining information used to construct the second protocol component via a recurrent query-response exchange between the second node and the first node.

9. The method of claim 1, further comprising:
connecting, by the inference engine, interfaces identified by the description to generate the composite model; and
mapping, by the inference engine, the composite model to a plurality of components of the first node, the plurality of components comprising at least one of a software component, a hardware component, and a firmware component.

10. The method of claim 1, further comprising:
generating, by the inference engine, the composite model using a correct-by-construction process.

11. The method of claim 1, further comprising:
using an instantiation parameter to construct the second protocol component.

12. The method of claim 1, wherein the second node and the first node comprise a same base software-defined radio ontology.

13. The method of claim 1, wherein the second node uses a different software architecture and different hardware architecture than the first node.

14. A system to reconfigure a connection protocol, comprising:
an interface module of a first node configured to receive, from a second node with which it communicates using a first protocol over a connection, a request to reconfigure the connection to operate on a second protocol;
an agent executing on a processor of the first node configured to:
determine that the first node requires a protocol component to communicate using the second protocol; and
request a description of the second protocol based on the determination;
an inference engine executing on the first node configured to:
receive, via the second node, the description of the second protocol, the description comprising a structural description and a state machine description;
generate a composite model of the second protocol based on the structural description and the state machine description; and
use the composite model to construct a second protocol component configured to communicate using the second protocol; and
the interface module further configured to transmit, via the constructed second protocol component of the first node, a signal to the second node using the second protocol.

15. The system of claim 14, wherein:
the second protocol comprises at least one of an encryption protocol and an authentication protocol that are different from the first protocol.

16. The system of claim 14, wherein the first node is further configured to:
receive the description in an ontology language.

17. The system of claim 14, wherein the first node is further configured to:
receive rules corresponding to the description of the second protocol; and
generate the composite model based on the rules.

18. The system of claim 14, wherein the first node is further configured to:
determine, responsive to receiving the description of the second protocol, that the first node requires an additional protocol component to communicate using the second protocol;
based on the determination, request a second description of the additional component; and
receive the second description corresponding to the additional component, the second description being lower level than the description.

19. The system of claim 14, wherein the inference engine is further configured to:
map the composite model to a plurality of components of the first node, the plurality of components comprising at least one of a software component, a hardware component, and a firmware component; and
connect the plurality of components to construct the second protocol component.

20. The system of claim 14, wherein the inference engine is further configured to:
generate the composite model using a correct-by-construction process.
